(19) United States
(12) Patent Application Publication
(10) Pub. No.: US 2023/0406074 A1
(43) Pub. Date: Dec. 21, 2023

(54) VENTILATION, HEATING AND/OR AIR CONDITIONING INSTALLATION FOR A VEHICLE

(71) Applicant: VALEO SYSTEMES THERMIQUES, La Verriere (FR)

(72) Inventors: Cyril GONTIER, La Verriere (FR); Yves ROUSSEAU, La Verriere (FR); Phillippe PIERRES, La Verriere (FR)

(73) Assignee: VALEO SYSTEMES THERMIQUES, La Verriere (FR)

(21) Appl. No.: 18/253,421

(22) PCT Filed: Nov. 18, 2021
(86) PCT No.: PCT/EP2021/082230

§ 371 Date: May 18, 2023

(30) Foreign Application Priority Data
Nov. 20, 2020 (FR) 2011955

(51) Int. Cl. B60H 1/34

(52) U.S. Cl. CPC B60H 1/3414

(57) ABSTRACT

The present invention relates to a ventilation, heating and/or air conditioning installation for a vehicle, with distribution unit including a thermal conditioning device, a mixing chamber and a cold air duct. The distribution unit includes a first air outlet and a second air outlet connected to the mixing chamber. The air outlets are delimited by two long edges and by two short edges substantially perpendicular to each other, with the air intake opening, the first inlet into the mixing chamber and the second inlet into the mixing chamber being arranged in this order in a main direction of extension of the short edges. The first and second air outlets are arranged in this order in the main direction of extension of the two short edges. The installation includes a scoop arranged across the first air outlet and configured to guide the mixed air flow toward the second air outlet.

### TECHNICAL FIELD

The present invention relates to the field of ventilation, heating and/or air conditioning installations for a motor vehicle. More particularly, the present invention relates to the field of air guide devices arranged within these ventilation, heating and/or air conditioning installations.

### BACKGROUND OF THE INVENTION

In a known manner, motor vehicles are commonly equipped with air treatment systems which make it possible to manage the overall temperature of the air in the passenger compartments of such vehicles. In particular, in the event of cold temperatures outside, these air treatment systems make it possible to heat the outside air in order to send it into the passenger compartment to heat the latter and, in the event of hot temperatures outside, these air treatment systems make it possible to cool the outside air in order to send it into the passenger compartment to lower the temperature therein. These air treatment systems can also be used to demist the glazed surfaces of the passenger compartment in order to ensure good visibility for the driver.

These systems conventionally comprise a housing in which are received at least one ventilation member for generating an air flow, for example by drawing in outside air, and at least one heat exchanger through which a heat transfer fluid passes, this making it possible to thermally condition the air flow circulating in the housing.

Once thermally conditioned, the air flow is directed toward the various air vents of the vehicle as required by the passengers of this vehicle. To this end, these air treatment systems can include one or more air flow guide devices. For example, these guide devices can be adjustable flaps and/or scoops.

One disadvantage of the air treatment systems currently used lies in the fact that they tend to generate stratification of the air flow. In other words, these systems tend to create temperature disparities between the various air outlets. Such disparities are not desirable because they make it more difficult to manage the average temperature within the passenger compartment of the vehicle.

### SUMMARY OF THE INVENTION

The present invention falls within this context, proposing a ventilation, heating and/or air conditioning installation in which the distribution of the air between the various outlets is carried out, at least partially, by means of a member arranged in such a way as to capture a mixed air flow across the entire transverse extent of the mixing chamber, thereby avoiding capturing a hot layer or a cold layer that can persist in the mixed air flow.

A subject of the present invention thus relates to a ventilation, heating and/or air conditioning installation for a vehicle, comprising at least one distribution unit through which an air flow is intended to pass, the distribution unit comprising at least one device for thermal conditioning of the air flow, a mixing chamber, a cold air duct which extends from an air intake opening in the distribution unit to a first inlet of the mixing chamber and a hot air duct which extends from the thermal conditioning device to a second inlet of the mixing chamber, the distribution unit comprising at least a first air outlet and at least a second air outlet aeraulically connected to the mixing chamber, the first air outlet and the second air outlet being respectively delimited by at least two long edges and by at least two short edges substantially perpendicular to the two long edges, the air intake opening, the first inlet into the mixing chamber and the second inlet into the mixing chamber being arranged in this order in a main direction of extension of at least one of the short edges which help to delimit the first air outlet and the air intake opening, the first air outlet and the second air outlet being arranged in this order in the main direction of extension of at least one of the short edges which help to delimit the first air outlet. According to the invention, the ventilation, heating and/or air conditioning installation comprises at least one scoop arranged across the first air outlet extending from one long edge to the other long edge of the first outlet, the scoop being configured to guide a mixed air flow toward the second air outlet. In this case, “mixed air flow” means an air flow made up of air coming from the cold air channel and air coming from the hot air channel.

Note therefore that a first portion of the mixed air flow leaves the distribution unit through the first air outlet and that a second portion of this mixed air flow leaves the distribution unit through the second air outlet. According to the invention, the scoop extends mainly in a direction transverse to a direction of the first portion of the mixed air flow and it has for example a curved profile in such a way as to direct the second portion of the mixed air flow toward the second air outlet.

Thus, the scoop arranged across the first air outlet formed in the distribution unit of the ventilation, heating and/or air conditioning installation according to the invention makes it possible to homogenize the temperature of the first portion of the mixed air flow leaving the distribution unit through the first air outlet and the temperature of the second portion of this mixed air flow leaving the distribution unit through the second air outlet.

According to the invention, the scoop has at least one free edge which extends mainly in a direction perpendicular to the long edges of the first air outlet between which it extends. In other words, this free edge extends parallel to the short edges which delimit this first air outlet.

According to one feature of the invention, the distribution unit is configured such that a first portion of the mixed air flow leaves through the first air outlet in a first direction, while a second portion of this mixed air flow leaves through the second air outlet in a second direction, the first direction being secant to the second direction. For example, the first direction of the first portion of the mixed air flow can be transverse to a plane in which the two long edges and the two short edges which help to delimit the first air outlet are inscribed. In other words, the first direction of the first portion of the mixed air flow is transverse to a main plane of extension of a section of the first air outlet. Advantageously, provision can be made for the second direction of the second portion of the mixed air flow to be transverse to a main plane of extension of a section of the second air outlet.

According to one embodiment of the invention, the scoop can have a concave shape, seen from an internal volume of the distribution unit of the ventilation, heating and/or air conditioning installation. According to the invention, this internal volume is defined by a peripheral wall of the distribution unit and this internal volume houses the at least one thermal conditioning device. Advantageously, such a shape of the scoop allows it to direct at least the second portion of the mixed air flow toward the second air outlet while reducing both pressure losses and the noise generated by the scoop.

For example, the first air outlet can be divided into a central outlet intended to supply a central air vent of the vehicle and at least one side outlet intended to supply a side air vent of the vehicle, the central outlet being divided from the side outlet by a dividing wall which extends in a plane secant to a main plane of extension of the scoop, the dividing wall extending between the two long edges which help to delimit the first air outlet. According to one arrangement of the invention, the scoop protrudes from the dividing wall. Advantageously, the scoop can be produced in one piece with the dividing wall from which it protrudes, that is to say that the dividing wall and the scoop form a single assembly which cannot be separated without causing damage to the scoop and/or to the dividing wall. In other words, it is understood that the dividing wall and the scoop can form an assembly which is generally L-shaped.

According to one feature of the invention, the scoop can be arranged in the extension of at least one of the long edges of the second air outlet. Advantageously, the dividing wall is arranged in the extension of at least one of the short edges of the second air outlet.

According to one embodiment of the invention, the ventilation, heating and/or air conditioning installation comprises at least two dividing walls, a first dividing wall delimiting the central outlet intended to supply the central air vent of the vehicle from a first side outlet intended to supply a first side air vent of the vehicle, and a second dividing wall delimiting the central outlet from a second side outlet intended to supply a second side air vent of the vehicle.

According to one feature of this embodiment, the first dividing wall is arranged in the extension of a first short edge of the second air outlet and the second dividing wall is arranged in the extension of a second short edge of the second air outlet. Advantageously, a first distance measured between the two dividing walls is equivalent to a second distance measured between the two short edges which help to delimit the second air outlet, these distances being measured perpendicular to at least one of these two short edges.

Optionally, the ventilation, heating and/or air conditioning installation can comprise at least two scoops, a first scoop protruding from the first dividing wall and a second scoop protruding from the second dividing wall. It is understood that the first scoop and the second scoop can respectively comprise all or some of the features described above with reference to the “scoop”. Thus, the first scoop can be produced in one piece with the first dividing wall and the second scoop can be produced in one piece with the second dividing wall. Alternatively, the scoops and the dividing walls can be separate and then rigidly secured to one another by any known means, without departing from the scope of the present invention.

When the ventilation, heating and/or air conditioning installation comprises two scoops, a ratio between a section of these two scoops and a section of the first air outlet measured between the long edges and the two dividing walls is between 0.13 and 0.20. Furthermore, provision can be made for a ratio between the section of the two scoops and a section of the first air outlet measured between the long edges and the short edges of this first air outlet to be between 0.07 and 0.12.

The present invention also relates to a motor vehicle equipped with at least one ventilation, heating and/or air conditioning installation as mentioned above.

### BRIEF DESCRIPTION OF DRAWINGS

The further features, details and advantages of the invention will become more clearly apparent both from the following description and from a number of embodiments provided by way of non-limiting indication with reference to the attached schematic drawings, in which:

FIG. 1 is an end-on view of a ventilation, heating and/or air conditioning installation according to one embodiment of the present invention;

FIG. 2 is a view in cross-section of a distribution unit of the ventilation, heating and/or air conditioning system according to the embodiment shown in FIG. 1;

FIG. 3 is a partial perspective view of the distribution unit of the ventilation, heating and/or air conditioning installation according to the invention; and

FIG. 4 is a detail view, taken from FIG. 2, of a portion of the distribution unit of the ventilation, heating and/or air conditioning installation in which at least a first air outlet and a second air outlet are formed.

### DETAILED DESCRIPTION OF THE INVENTION

In the remainder of the description, the terms “longitudinal”, “transverse” and “vertical” refer to the orientation of the object concerned in a reference system L, V, T shown in the figures, in which a longitudinal direction is parallel to a longitudinal axis L, a vertical direction is parallel to a vertical axis V and a transverse direction is parallel to a transverse axis T, the longitudinal axis L, the vertical axis V and the transverse axis T each being perpendicular to the other two. In the description, a cross-section is made in a transverse and vertical plane, that is, in a plane containing the transverse axis and the vertical axis of the trihedron shown.

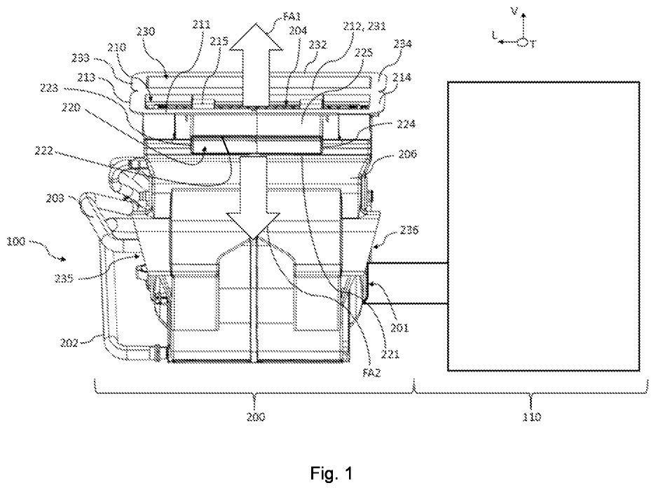

FIG. 1 shows, seen end-on, a ventilation, heating and/or air conditioning installation 100 according to one embodiment of the invention. In the remainder of the description, the terms “ventilation, heating and/or air conditioning installation” and “installation” will be used indiscriminately.

Installation 100 includes at least one distribution unit 200 and can optionally include at least one ventilation unit 110. If necessary, this ventilation unit 110 houses at least one ventilation device configured to generate an air flow and it thus comprises at least one air inlet and at least one air discharge orifice, the air inlet being in communication with an environment external to the installation 100 and the air discharge orifice being itself in communication with an intake opening 201 of the distribution unit 200. In other words, the air discharge orifice of the ventilation unit 110 coincides with an air inlet of the distribution unit 200. As the ventilation unit 110 is shown here schematically, neither the ventilation device nor the air inlet nor the air discharge orifice are depicted.

For example, the ventilation device can be a volute ventilation device configured to draw in an air flow in a first axial direction and to propel same in a second radial direction, in other words, this second direction is perpendicular, or substantially perpendicular, to the first direction. Note that this is only one embodiment, and that any other type of known ventilation device can be used without departing from the scope of the present invention.

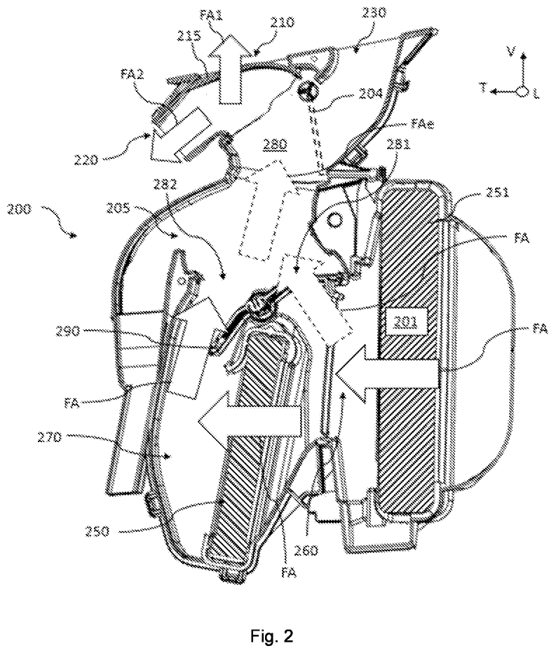

The distribution unit 200 comprises a peripheral wall 206 which defines an internal volume in which is housed at least one thermal conditioning device 250 for the air flow. As partially shown in FIG. 2, this thermal conditioning device 250 comprises a heat exchanger arranged on a heat transfer fluid circuit and this heat exchanger is adapted to effect a heat exchange between the air flow and the heat transfer fluid. The heat transfer fluid circuit extends mainly outside the internal volume. For example, the heat transfer fluid circuit comprises the thermal conditioning device configured to heat the air flow and at least one heat exchanger 251—also visible in FIG. 2—configured to effect a heat exchange between the heat transfer fluid and the air flow in such a way as to cool this air flow. As shown in FIG. 2, this heat exchanger 251 is also received in the internal volume of the distribution unit.

FIG. 1 also shows an inlet pipe 202 for the heat transfer fluid and a discharge pipe 203 for this heat transfer fluid, this inlet pipe 202 and this discharge pipe 203 both being fluidically connected to the heat exchange device.

According to the invention, at least two air outlets are formed in the peripheral wall 206 of the distribution unit 200. A first air outlet 210 is thus adapted to be connected at least to a central air vent of the vehicle for which the installation 100 according to the invention is intended, and a second air outlet 220 is adapted to be connected to one or more rear air vents of this vehicle. Note that the adjectives used to qualify the various air vents of the vehicle refer to a conventional compartmentalization of the passenger compartment of the vehicle in which the front is formed by a part of the passenger compartment closest to the front of the vehicle and in which the rear is formed by a part of this passenger compartment closest to the rear of the vehicle. According to the example shown here, the distribution unit 200 further comprises at least a third air outlet 230 adapted to be connected to an air vent arranged at the bottom of the windshield in the vehicle, in other words this air vent makes it possible to defrost and/or demist the windshield when necessary. Lastly, the distribution unit 200 includes a fourth air outlet 235 and a fifth air outlet 236 both adapted to be connected to an air vent arranged at the bottom of the rear windshield of the vehicle.

As described in detail below, with reference to FIG. 2, the air flow generated by the ventilation device leaves the distribution unit 200 in a direction which is transverse, advantageously perpendicular, to a main plane of extension of a section of the air outlet concerned.

According to the example shown, each air outlet 210, 220, 230 is delimited by at least four edges which are inscribed, respectively, in the main plane of extension of the section of the air outlet concerned. In other words, all four of the edges which delimit an air outlet extend, respectively, in directions which are transverse, advantageously perpendicular, to the direction of the air flow leaving the aforementioned air outlet. As shown, the air flow leaves the first outlet 210 in a first direction of movement FA1 and the air flow leaves the second outlet 220 in a second direction of movement FA2.

According to the example shown, the air outlets 210, 220, 230 formed in the peripheral wall 206 of the distribution unit 200 have rectangular, or substantially rectangular, sections, in other words each air outlet 210, 220, 230 is delimited by at least two long edges 211, 212, 221, 222, 231, 232 which are parallel to one another and by at least two short edges 213, 214, 223, 224, 233, 234 which are parallel to one another and which connect the two long edges in question, the short edges and long edges being substantially, and even strictly, perpendicular. According to the orientation given in the figures, the two long edges 211, 212 which help to define the first air outlet 210 extend in longitudinal directions and the two short edges 213, 214 which help to define the first air outlet air 210 extend in transverse directions.

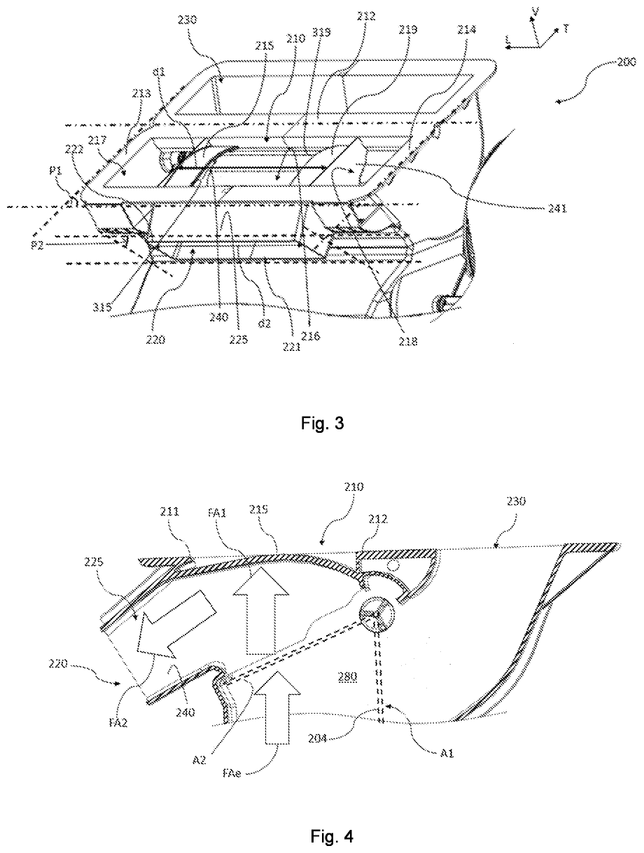

Furthermore, the second air outlet 220 is formed at a free end of a channel 225 which extends, at least in part, from one of the long edges 211 which help to delimit the first air outlet 210, away from this first air outlet 210 and also away from the third air outlet 230. As a result of this arrangement, a main plane of extension P1 of the section of the first air outlet 210 is secant to a main plane of extension P2 of the section of the second air outlet 220. These main planes of extension P1, P2 of the sections of the first and second air outlets 210, 220 are for example shown in FIG. 3.

Moreover, according to the example shown, the first air outlet 210 and the third air outlet 230 have a common edge 212, 231, in this case formed by one of the long edges which help to delimit these first and third air outlets 210, 230. As can be seen in FIG. 3, a section of the third air outlet 230 also extends in the plane of extension P1 of the section of the first air outlet 210.

It is understood from the above that the second air outlet 220 and the third air outlet 230 are distributed transversely on either side of the first air outlet 210.

As can be seen partially in FIG. 1, at least one adjustable flap 204 is arranged in the internal volume of the distribution unit 200 in such a way as to guide the air flow circulating in this internal volume toward one or other of the air outlets 210, 220, 230 mentioned above.

According to the invention, at least one scoop 215 is arranged across the first outlet 210. This scoop 215 is described more particularly below with reference to FIGS. 3 and 4.

FIG. 2 is a view in cross-section of the distribution unit 200, this cross-section being made in a transverse plane which passes through the scoop 215. FIG. 2 thus gives a particularly clear view of the internal volume 205 of the distribution unit 200 and of the heat exchange device 250 and the heat exchanger 251 received in this internal volume 205. The distribution unit 200 could however not contain the heat exchanger 251, without departing from the scope of the present invention.

It is understood from reading FIGS. 1 and 2 that the intake opening 201 of the distribution unit is, according to the example shown here, formed opposite the heat exchanger 252 and this intake opening 201 is therefore referenced schematically in FIG. 2.

The internal volume 205 of the distribution unit 200 also comprises at least a cold air channel 260, a hot air channel 270, a mixing chamber 280 and at least one guide device 290 for guiding the air flow FA. As shown, the cold air channel 260 extends between the intake opening 201 and a first inlet 281 of the mixing chamber 280, while the hot air channel 270 extends between the thermal conditioning device 250 and a second inlet 282 of the mixing chamber 280. According to the example shown, the guide device 290 is in a position in which it only allows the air flow from the hot air channel 270 to reach the mixing chamber 280. Advantageously, this guide device 290 is movable and can take up various positions in which it allows the air circulating in the cold air channel 260 and in the hot air channel 270 to reach the mixing chamber 280, or prevents said air from doing so. The first air outlet 210 and the second air outlet 220 are for their part formed in a portion of the peripheral wall 206 which delimits the mixing chamber 280.

As shown, the abovementioned adjustable flap 204 is received in the mixing chamber 280. This adjustable flap 204 makes it possible to direct the air present in the mixing chamber 280 toward one of the air outlets 210, 220, 230 and is described in more detail below with reference to FIG. 4.

As shown, the intake opening 201, the first inlet 281 of the mixing chamber 280 and the second inlet of the mixing chamber 282 are arranged in this order in the transverse direction, i.e. in the main direction of extension of at least one of the short edges which help to delimit the first air outlet 210. Moreover, the intake opening 201, the first air outlet 210 and the second air outlet 220 are arranged in this order in the transverse direction, i.e. in the main direction of extension of at least one of the short edges which help to delimit the first air outlet 210.

According to a mode of operation shown, the air flow FA generated by the ventilation device reaches the internal volume 205 of the distribution unit 200 through the intake opening 201 and thus arrives in the cold air channel 260. With the guide device 290 in the position shown, all of this air flow FA is then directed toward the thermal conditioning device 250 within which it captures heat energy from the heat transfer fluid circulating in this thermal conditioning device 250 in such a way as to be heated. On leaving the thermal conditioning device 250, the air flow FA thus reaches the hot air channel 270, before reaching the mixing chamber 280 via its second inlet 282. Once in the mixing chamber 280, and with the adjustable flap 204 in the position shown in FIG. 2, a first portion of this air flow FA leaves the distribution unit 200 through the first outlet 210 in the first direction FA1 and a second portion of this air flow FA leaves the distribution unit 200 through the second outlet 220 in the second direction FA2.

According to another mode of operation, the guide device 290 can be in a position in which only a portion of the air flow FA leaving the cold air channel 260 passes through the thermal conditioning device 250 before reaching the hot air channel 270 then the mixing chamber 280 and in which another portion of the air flow FA—shown in broken lines—leaving the cold air channel 260 directly reaches the mixing chamber 280 through the first inlet 281. This results in the formation of a mixed air flow FAe—shown in broken lines—in the mixing chamber 280. Therefore, with the adjustable flap 204 in the position shown in FIG. 2, a first portion of this mixed air flow FAe leaves the distribution unit 200 through the first outlet 210 in the first direction FA1 and a second portion of this mixed air flow FAe leaves the distribution unit 200 through the second outlet 220 in the second direction FA2.

As the second outlet 220 is closer to the hot air channel than the first outlet 210, the presence of the abovementioned scoop 215, the operation of which will be described in more detail below, makes it possible to homogenize the temperature of the first portion of the mixed air flow FAe and the second portion of the mixed air flow FAe in order to obtain a homogeneous temperature within the passenger compartment of the vehicle equipped with the installation according to the invention.

According to yet another mode of operation not shown here, the guide device 290 can be in a position in which it closes off the second inlet 282 of the mixing chamber 280 such that all of the air flow FA leaving the cold air channel 260 can reach the mixing chamber 280.

FIG. 3 is a partial perspective view of the distribution unit 200 of the ventilation, heating and/or air conditioning installation according to the invention. More specifically, FIG. 3 is a close-up view of the first, second and third air outlets formed in this distribution unit 200. As mentioned above, FIG. 3 shows the at least one scoop 215 arranged across the first outlet 210. More specifically, according to the example shown, a first scoop 215 and a second scoop 219 are arranged across the first air outlet 210.

The description below relates to the first scoop 215 but it also applies, mutatis mutandis, to the second scoop 219.

As shown, the first scoop 215—hereinafter referred to as the “scoop 215”—extends mainly in a direction parallel, or substantially parallel, to the short edges 213, 214 which help to delimit the first air outlet 210, between the two long edges 211, 212 which also help to delimit this first air outlet 210. More specifically, the scoop 215 extends from one of the long edges 211 as far as the other of these long edges 212, in such a way that it is in contact with each of these long edges 211, 212. Lastly, note that the scoop 215 is positioned in the extension of one of the long edges 221, 222 which help to delimit the second air outlet 220. This scoop 215 is also arranged in the extension of the abovementioned channel 225 which opens out at the second air outlet 220. This scoop 215 is configured to direct a portion of the air flow circulating in the mixing chamber of the distribution unit 200 toward the channel 225 and therefore toward the second air outlet 220 formed at the free end of this channel 225. Advantageously, this scoop 215 is positioned flush with the first air outlet 210. In other words, the position of this scoop 215 is chosen such that the air flow is guided toward the second air outlet 220 at the last moment, that is to say just before the air flow leaves the internal volume of the distribution unit, and such that the whole of the air flow present in the mixing chamber is thus guided. Such an arrangement is particularly advantageous when the air flow present in the mixing chamber is a mixed air flow.

As mentioned above, the second air outlet 220 is closer to the hot air channel than the first air outlet 210, while this first air outlet 210 is closer to the cold air channel, such that when the air flow in the mixing chamber is a mixed air flow, stratification can occur, which results in a significant difference in temperature between the first portion of the mixed air flow leaving the distribution unit through the first outlet 210 and the second portion of this mixed air flow leaving the distribution unit through the second outlet 220. The position—described above—and the shape—described below with reference to FIG. 4—of this scoop 215 make it possible to direct the air flow toward the channel 225 and therefore toward the second air outlet 220 at the last moment, that is to say the instant at which the temperature of the air flow circulating in the internal volume of the distribution unit 200 is most homogeneous. In other words, this scoop 215 makes it possible to adapt the aerothermal behavior of the installation to stratification phenomena and therefore it makes it possible to better control the temperature of each of the air flows leaving the distribution unit 200 and, ultimately, to better control the overall temperature in the passenger compartment of the vehicle.

FIG. 3 also shows a first dividing wall 240 and a second dividing wall 241 which separate, respectively, a central outlet 216 adapted to be connected to the central air vent of the vehicle from a first side outlet 217 adapted to be connected to a first side air vent of the vehicle, and the central outlet 216 from a second side outlet 218 adapted to be connected to a second side air vent. The two dividing walls 240, 241 extend, respectively, in a direction parallel to the short edges 213, 214 which help to delimit the first air outlet 210, at least between the two long edges 211, 212 which also help to delimit this first air outlet 210. These dividing walls 240, 241 also extend, at least in part, in the internal volume of the distribution unit 200. In other words, these dividing walls 240, 241 extend, respectively, in planes which are transverse, advantageously perpendicular, to the main plane of extension P1 of the section of the first air outlet 211 Note that this is only one embodiment of the invention and that the distribution unit could comprise a single dividing wall or none at all, without departing from the scope of the present invention.

According to the example shown, at least two scoops 215, 219 are arranged across the first outlet 210, a first scoop 215 being arranged between the central outlet 216 and the first side outlet 217 and a second scoop 216 being arranged between the central outlet 216 and the second side outlet 218. As shown, the first scoop 215 thus protrudes from the first dividing wall 240 which is arranged in the extension of one of the short edges 223 which help to delimit the second air outlet 220 and the second scoop 219 itself protrudes from the second dividing wall 241 which is arranged in the extension of the other of these short edges 224. In other words, a first distance d1 measured between the two dividing walls 240, 241 is equivalent to a second distance d2 measured between the two short edges 223, 224 which help to delimit the second air outlet 220, along an axis perpendicular to at least one of these short edges 223, 224.

Advantageously, the first scoop 215 and the second scoop 219 can be produced in one piece with the dividing wall 240, 241 from which they protrude. In other words, the first scoop 215 and the first dividing wall 240 form a single assembly which cannot be separated without causing damage to at least one of them and the second scoop 219 and the second dividing wall 241 also form a single assembly which cannot be separated without causing damage to at least one of them. Note that the dividing walls and the scoops could be rigidly secured to one another in pairs by added means, such as adhesive or screws for example, without departing from the scope of the present invention.

Thus, each scoop 215, 219 extends, on the one hand, between the two long edges 211, 212 which help to delimit the first air outlet 210, in contact with the latter, and on the other hand, between the one of the dividing walls 240, 241 and a free edge 315, 319 which delimits the scoop. As shown, the free edge 315, 319 of each scoop 215, 219 extends parallel to the short edges 213, 214 which help to delimit the first air outlet 210.

In particular, the “scoop and dividing wall” assembly is generally L-shaped, one branch of the L being formed by the scoop and the other branch being formed by the corresponding dividing wall.

According to the example shown in the figures, the scoops 215, 219 are arranged such that a ratio between a section of these two scoops 215, 219 and a section of the first air outlet 210 measured between the long edges 211, 212 and the two dividing walls 240, 241 is between 0.13 and 0.20. Furthermore, according to the example shown, a ratio between the section of the two scoops 215, 219 and a section of the first air outlet 210 measured between the long edges 211, 212 and the short edges 213, 214 of this first air outlet 210 is between 0.07 and 0.12.

Lastly, FIG. 4 is a detail view, taken from FIG. 2, of a portion of the mixing zone 280, this detail view showing particularly clearly the first air outlet 210, the second air outlet 220, the third air outlet 230, one of the scoops 215 and the adjustable flap 204 mentioned above.

This adjustable flap 204 is thus received in the mixing chamber 280 and can take up at least two positions of this adjustable flap 204. Thus, this adjustable flap 204 can take up a first position A1 in which the air flow circulating in the mixing chamber 280 is directed toward the first air outlet 210 and toward the second air outlet 220, that is to say that the adjustable flap 204 closes off the third air outlet 230, and a second position A2 in which the air flow circulating in the mixing chamber 280 is directed toward the third air outlet 230, it that is to say that it closes off the first air outlet 210 and the channel 225 which opens out at the second air outlet 220. Note that this adjustable flap 204 can also take up any intermediate position between the first position A1 and the second position A2 without departing from the scope of the present invention.

The remainder of the description relates more particularly to the mode of operation in which the guide device is positioned such that the mixed air flow FAe, that is to say a mixture between the air flow coming from the cold air channel and the air flow coming from the hot air channel, circulates in the mixing chamber 280. To be specific, as mentioned above, this is the mode of operation in which the presence of the scoop 215 is most beneficial.

As mentioned above, the scoop 215 is configured to direct a portion of the mixed air flow FAe toward the second air outlet 220 such that the first portion of the mixed air flow FAe leaving the mixing chamber 280 through the first outlet 210 and the second portion of the mixed air flow FAe leaving the mixing chamber 280 through the second outlet 220 have homogeneous temperatures. For this purpose, the scoop 215 has a curved shape. This curved shape is in this case concave, seen from the internal volume of the distribution unit 200, that is to say seen from the mixing chamber 280. Thus, a portion of the mixed air flow FAe arriving at the first air outlet 210 in the first direction FA1 described above, comes into abutment against the scoop 215 and follows the curve of this scoop 215, toward the second air outlet 220. In other words, this scoop 215 makes it possible to change the direction of movement of a portion of the mixed air flow FAe so that the latter moves in the second direction of movement FA2 and can thus reach the channel 225 so as to leave the distribution unit 200 through the second air outlet 220. Note that the scoop 215 extends from one long edge to the other of the first air outlet 210, so that this scoop 215 captures both the mixed air flow FAe which is close to the first long edge 211 of the first air outlet 210 and the mixed air flow FAe which is close to the second long edge 212 of this first air outlet 210.

FIG. 4 again shows the first dividing wall 240 described above which makes it possible to separate the central outlet from the first side outlet. Lastly, note that, according to the example shown, the scoop 215 is produced in one piece with the peripheral wall 206 of the distribution unit 200, that is to say that this scoop 215 and this peripheral wall 206 form a single assembly and that they cannot be separated without causing damage to the scoop 215 and/or the peripheral wall 206.

The present invention thus proposes a simple and inexpensive means which makes it possible to distribute the air flow toward the various air outlets of a ventilation, heating and/or air conditioning installation of a motor vehicle, while taking into account the phenomenon of stratification which tends to complicate the aerothermal management of such an installation.

The present invention is not limited to the means and configurations described and illustrated in the present document, however, and it also extends to all equivalent means and configurations and to any technically feasible combination of such means. In particular, the number and the shape of the scoops can be modified without detriment to the invention, as long as they provide the functionalities described in the present document.

What is claimed is:

1. A ventilation, heating and/or air conditioning installation for a vehicle, comprising at least one distribution unit through which an air flow is intended to pass, the at least one distribution unit including at least one air flow thermal conditioning device, a mixing chamber for mixing the air flow, a cold air duct which extends from an air intake opening in the at least one distribution unit to a first inlet of the mixing chamber and a hot air duct which extends from the at least one air flow thermal conditioning device to a second inlet of the mixing chamber, the at least one distribution unit including at least a first air outlet and at least a second air outlet aeraulically connected to the mixing chamber, the first air outlet and the second air outlet each being respectively delimited by at least two long edges and by at least two short edges substantially perpendicular to the at least two long edges, with the air intake opening, the first inlet inlet into the mixing chamber and the second inlet into the mixing chamber being arranged in this order in a main direction of extension of at least one of the at least two short edges which delimit the first air outlet and the air intake opening, the first air outlet and the second air outlet being arranged in this order in the main direction of extension of at least one of the at least two short edges which delimit the first air outlet, wherein the ventilation, heating and/or air conditioning installation further comprises a first scoop arranged across the first air outlet extending from one long edge of the at least two edges to the other long edge of the at least two edges of the first outlet, the at least one scoop being configured to guide the mixed air flow toward the second air outlet.

2. The ventilation, heating and/or air conditioning installation as claimed in claim 1, wherein the first scoop has at least one free edge which extends mainly in a direction perpendicular to the at least two long edges of the first air outlet.

3. The ventilation, heating and/or air conditioning installation as claimed in claim 1, wherein the at least one distribution unit is configured such that a first portion of the mixed air flow leaves through the first air outlet in a first direction, while a second portion of the mixed air flow leaves through the second air outlet in a second direction, the first direction being secant to the second direction.

4. The ventilation, heating and/or air conditioning installation as claimed in claim 3, wherein the first direction of the first portion of the mixed air flow is transverse to a plane in which the at least two long edges and the at least two short edges which delimit the first air outlet are inscribed.

5. The ventilation, heating and/or air conditioning installation as claimed in claim 1, wherein the first scoop has a concave shape.

6. The ventilation, heating and/or air conditioning installation as claimed in claim 1, wherein the first air outlet is divided into a central outlet intended to supply a central air vent of the vehicle and a first side outlet intended to supply a side air vent of the vehicle, the central outlet being divided from the first side outlet by a first dividing wall which extends in a plane secant to a main plane of extension of the first scoop, the first dividing wall extending between the at least two long edges which delimit the first air outlet.

7. The ventilation, heating and/or air conditioning installation as claimed in claim 6, wherein the first scoop protrudes from the first dividing wall.

8. The ventilation, heating and/or air conditioning installation as claimed in claim 1, wherein the first scoop is arranged in the extension of at least one of the at least two long edges of the second air outlet.

9. The ventilation, heating and/or air conditioning installation as claimed in claim 6, wherein the first dividing wall is arranged in the extension of at least one of the at least two short edges of the second air outlet.

10. The ventilation, heating and/or air conditioning installation as claimed in claim 6, further comprising a second dividing wall separating the central outlet from a second side outlet intended to supply a second side air vent of the vehicle.

11. The ventilation, heating and/or air conditioning installation as claimed in claim 10, further comprising at least a second scoop, with the first scoop protruding from the first dividing wall and the second scoop protruding from the second dividing wall, wherein a ratio between a section of the first and second scoops and a section of the first air outlet measured between the at least two long edges and the first and second dividing walls is between 0.13 and 0.20.
